(19) United States
(12) Patent Application Publication
(10) Pub. No.: US 2008/0205961 A1
(43) Pub. Date: Aug. 28, 2008

(54) Polymeric gel-cushioned keyboard keys

(76) Inventor: Brian Stachurski, Mercer Island, WA (US)

Correspondence Address: BLACK LOWE & GRAHAM, PLLC, 701 FIFTH AVENUE, SUITE 4800, SEATTLE, WA, 98104, US

(21) Appl. No.: 11/389,873

(22) Filed: Mar. 27, 2006

Related U.S. Application Data
(60) Provisional application No. 60/739,088, filed on Nov. 22, 2005.

(51) Int. Cl. B41J 5/00

(52) U.S. Cl. 400/490

(57) ABSTRACT

A key assembly for a keyboard. The key assembly includes a plunger assembly having an impact flange and a mantle coupled to the plunger assembly. The mantle includes a gel deformable by an actuation force.

### PRIORITY CLAIM

The present application claims priority from U.S. Provisional Application No. 60/739,088 filed Nov. 22, 2005, which is herein incorporated by reference.

### FIELD OF THE INVENTION

An embodiment of the invention relates generally to impact absorption technologies and, more specifically, to conformed cushion impact absorption.

### BACKGROUND OF THE INVENTION

An average typist generally enters text at about 420-440 keystrokes per minute on a standard keyboard. A standard keyboard activation force requires 80 Newtons. A Newton (N) is defined as the force needed to produce an acceleration of 1 m/s² on a 1 kg object. Therefore, 1 N=1 kg×1 m/s². Thus the force necessary to activate a standard keyboard would be sufficient to accelerate a one kilogram mass at 80 m/s².

Referring to FIG. 1, the finger 100 is a complex mechanical device. Covered with a skin or epidermis 101 and nail 104, the finger 100 is driven into impact with the key by the contraction of the flexor profondus digitorum (not shown) pulling the distal phalanx 107 and the middle phalanx 113 into rotating contact with the aurical cartilage 119. The contraction of the flexor profondus digitorum (not shown) drives the distal phalanx 107 downward, along with the dermis 110 and specifically the pad 116 of the finger into impact upon the key. The pad 116 is a fleshy protrusion on the finger and has a specific density much less than that of the hard tissue of the distal phalanx 107 providing some cushioning of the impact. Upon impact, however, damage to the microvessels that transport blood into the pad can occur as well as cellular damage to the dermis.

The approximately 420 impacts per second with an 80 Newton force have a wearing effect on the anatomy of the fingers of the typist. In some instances, calluses build and the typist sacrifices some sensation in the fingertips to endure the pain of repeated impacts. In other instances where, for example, prescribed blood thinning agents are used by the typist, the typist forms blood blisters in the fingertips.

One solution has been taught in U.S. Pat. No. 4,454,562, which places a spring beneath a rigid key surface allowing the key surface to compress a spring upon impact allowing the spring to compress until a threshold pressure for activation of a pressure switch is reached and exceeded, thereby activating the switch. Problematically, the rigid key surface and its mantle have a relatively high mass and therefore a great deal of inertia when the finger strikes the key. Impacts with the key still have a greater than optimal impulse occurring upon impact.

There is a need in the art for a cushioning key with a diminished impulse at the time of impact.

### SUMMARY OF THE INVENTION

According to one aspect of the invention, a key assembly of a keyboard is provided. The key assembly includes a plunger assembly having an impact surface and a mantle coupled to the plunger assembly. The mantle includes a gel deformable by an actuation force.

### BRIEF DESCRIPTION OF THE DRAWINGS

Preferred and alternative embodiments of the present invention are described in detail below with reference to the following drawings.

FIG. 1 is a cross-section of a human finger showing the hard and soft tissue thereof;

FIG. 2A is a first cross-sectional view of a gel-cushioned key according to an embodiment of the invention;

FIG. 2B is a second cross-sectional view of the gel-cushioned key of FIG. 2A;

FIG. 2C is an inverted view of the gel-cushioned key of FIG. 2A; and,

FIG. 2D is a side view of the gel-cushioned key of FIG. 2A.

### DETAILED DESCRIPTION OF THE PREFERRED EMBODIMENT

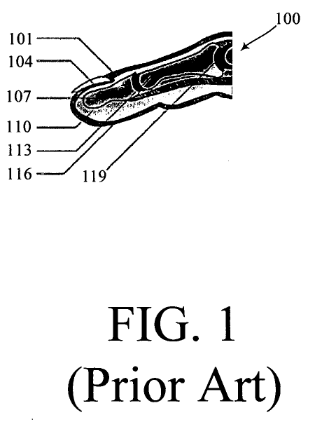

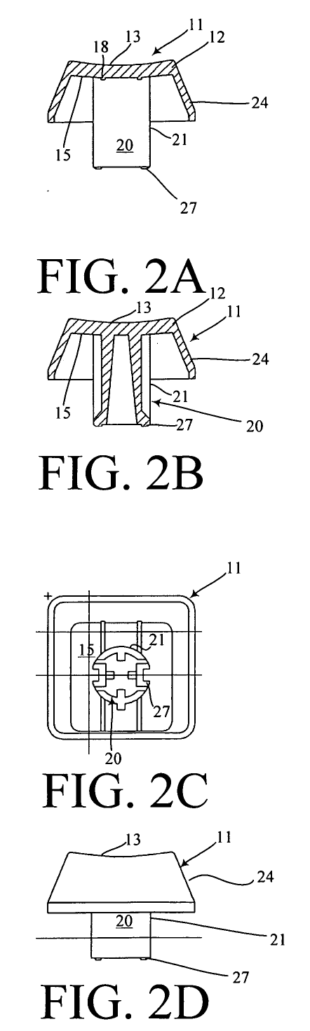

In an embodiment of the invention, and referring to FIGS. 2A-2D, a cushioned key 11 includes an elastomeric (or other functionally similar) gel mantle 12 having oblique lateral surfaces 24 surrounding an impact surface 13 configured to receive a finger pad 116 (FIG. 1) and be interposed between the finger pad 116 (FIG. 1) and a rigid impact flange 15 of the key at the time of impact. More specifically, the impact surface 13 is sized to be interposed between the finger pad 116 and and the key 11. The impact surface 13 should cover any surface of the key 11 to which a finger 100 may impart force to actuate the key 11 (e.g., impact the key with sufficient force (i.e., actuating force) to activate a keyboard actuator switch associated with the key). The impact flange 15 is, itself, suitably affixed to a plunger assembly 20.

By way of non-limiting example, the plunger assembly 20 includes components configured to attach to an actuator switch (not shown) of a keyboard (not shown) at an actuator switch shaft 21, attachment to the switch being facilitated, for example, by an opposed pair of resilient tabs 27 configured to fit corresponding depressions the actuator switch (not shown) defines.

The gel mantle 12 includes one of a number of soft gels in order to implement an embodiment of the invention, wherein the impact of the finger pad 116 (FIG. 1) on the impact surface 13 is softened. Soft gels may be derived, for example, from a polymer containing a plurality of urethane linkages (a polyurethane) and a high level of plasticizer. Such gels are typically used as energy absorbing material, as cushioning materials, and in many related applications. Further examples of specific applications of such materials include shoe inserts (such as arch supports), bicycle seat cushions, computer mouse pads, ergonomic elbow and wrist supports, helmet linings, and the like. These materials can be formulated to a consistency very similar to human fat or muscle (collectively, “soft tissue”). Such a consistency is ideal for supporting human body members that come into prolonged contact with an otherwise hard surface, such as the core of a bicycle seat.

Highly plasticized gels have viscoelastic properties well suited to impact protection. The soft gels are generally solid gels, but are sometimes foamed to a modest degree to produce microcellular soft elastomers. The polyurethane gels are often, although not always, used behind a layer of fabric or an elastomeric film material. They are sometimes completely encapsulated by one or more such flexible facing (or backing) materials. Sometimes these encapsulated polyurethane gels are not solid, but instead may be flowable (albeit highly viscous) liquids. In this special situation, the encapsulating structures retain the gel in place.

Polyurethane gels are typically formed from the reaction of a polyfunctional organic isocyanate with a polyfunctional isocyanate reactive material in the presence of a non-volatile inert liquid. The polyurethane component of the gel is typically crosslinked (thermoset) and the isocyanate reactive material contributes flexibility.

By formulating the gel mantle 12 to have the consistency and density of human fat, the mantle 12 shares the impact force with the impact flange 15 when struck by the finger 100 (FIG. 1) having the fatty pad 116 (FIG. 1). Suitable matching of viscosity and consistency of the gel mantle 12 with the viscosity and consistency of the fatty pad 116 will allow the distribution of the shock of impact with the key 11 on a keyboard (not shown) between the flesh of the fatty pad 116 (FIG. 1) and the gel mantle 12 by evening deformation rates upon impact of both. The deformation of the gel mantle 12 spreads out an impact interval to allow the transfer of momentum over a greater time making the maximum instantaneous impact on the finger 100 at any time a minimum.

While the preferred embodiment of the invention has been illustrated and described, as noted above, many changes can be made without departing from the spirit and scope of the invention. For example, plunger assemblies configured to engage alternate activator switches in operation of the actuator switch. Accordingly, the scope of the invention is not limited by the disclosure of the preferred embodiment.

I claim:

1. A key assembly of a keyboard comprising:
a plunger assembly having an impact flange; and,
a mantle coupled to the impact flange and comprising a gel deformable by an actuating force.

2. The assembly of claim 1 wherein the gel is a polymer containing a plurality of urethane linkages and a high level of plasticizer.

3. The assembly of claim 1 wherein the gel is a microcellular soft elastomer.

4. The assembly of claim 1 including a layer of fabric on an impact surface of the gel.

5. The assembly of claim 1 including a layer of elastomeric film material on an impact surface of the gel.

6. The assembly of claim 1 wherein the gel is encapsulated by one of a fabric and an elastomeric film material.

7. The assembly of claim 6 wherein the gel is a liquid.

8. The assembly of claim 1 wherein the gel has a consistency and a density approximately equal to a consistency and a density of human fat.

9. A mantle for an impact flange surface of a key assembly comprising:
a gel deformable by an actuating force; and,
a structure encapsulating the gel.

10. The assembly of claim 9 wherein the gel is a polymer containing a plurality of urethane linkages and a high level of plasticizer.

11. The assembly of claim 9 wherein the gel is a microcellular soft elastomer.

12. The assembly of claim 9 wherein the structure is a layer of fabric.

13. The assembly of claim 9 wherein the structure is a layer of elastomeric film material.

14. The assembly of claim 9 wherein the gel is a liquid.

15. The assembly of claim 9 wherein the gel has a consistency and a density approximately equal to a consistency and a density of human fat.

16. A keyboard assembly comprising:
a keyboard including at least one key assembly including a plunger assembly with an impact flange;
at least one mantle on the impact flange of the at least one key assembly, the mantle comprising:
a gel deformable by an actuating force.

17. The assembly of claim 16 wherein the gel has a consistency and a density approximately equal to a consistency and a density of human fat.

18. The assembly of claim 16 wherein the gel is a liquid.

19. The assembly of claim 18 wherein the gel is encapsulated by one of a fabric and an elastomeric film material.

20. A method of reducing the impact force experienced by a finger when actuating a key assembly comprising:
configuring a gel deformable by an actuating force to cover an impact flange of the key assembly; and,
coupling the gel to the actuation surface.

21. The method of claim 20 including encapsulating the gel in one of a fabric and an elastomeric film material.
